(19) United States
(12) Patent Application Publication
(10) Pub. No.: US 2014/0357268 A1
(43) Pub. Date: Dec. 4, 2014

(54) METHOD AND APPARATUS FOR EFFICIENT RADIO ACCESS TECHNOLOGY FREQUENCY SCANNING BASED ON FALSE ALARMS

(71) Applicant: QUALCOMM Incorporated, San Diego, CA (US)

(72) Inventors: Nishant DUBEY, Hyderabad (IN); Nilotpal Dhar, Hyderabad (IN)

(73) Assignee: QUALCOMM Incorporated, San Diego, CA (US)

(21) Appl. No.: 14/061,520

(22) Filed: Oct. 23, 2013

Related U.S. Application Data
(60) Provisional application No. 61/830,462, filed on Jun. 3, 2013.

(51) Int. Cl. H04W 48/16

(52) U.S. Cl. CPC H04W 48/16
USPC 455/434

(57) ABSTRACT

Efficient RAT frequency scanning based on false alarms is described. A first RAT associated with multiple frequency bands, and a first frequency band among the multiple frequency bands, may be selected. A first signal scan associated with the first RAT may be performed in the first frequency band to identify a candidate signal in the first frequency band. Determining that the candidate signal is not associated with the first RAT may signal a false alarm, and information related to the candidate signal may be stored as false alarm information. A second RAT associated with at least one of the multiple frequency bands, and a second frequency band among the at least one of the multiple frequency bands, may be selected based on the stored false alarm information. A second signal scan associated with the second RAT in the second frequency band may be performed.

### CLAIM OF PRIORITY UNDER 35 U.S.C. §119

The present application for patent claims priority to Provisional Application No. 61/830,462 entitled “METHOD AND APPARATUS FOR EFFICIENT RADIO ACCESS TECHNOLOGY FREQUENCY SCANNING BASED ON FALSE ALARMS” filed Jun. 3, 2013, and assigned to the assignee hereof and hereby expressly incorporated by reference herein.

### BACKGROUND

Aspects of the present disclosure relate generally to wireless communications and, more particularly, to method and apparatus for efficient radio access technology frequency scanning based on false alarms.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSDPA), which provides higher data transfer speeds and capacity to associated UMTS networks.

Multimode mobile devices or user equipment (UE) refer to mobile phones that are compatible with more than one form of data transmission or network, as contrasted with single-mode mobile devices, which are compatible with just one form of data transmission or network. For instance, a dual-mode phone is a phone that uses more than one technique for sending and receiving voice and data. Further, multiband UEs refer to mobile phones that are capable of working in different frequency bands within one or more modes. UEs may be both multimode and multiband.

In a conventional system, upon powering up, a multiband/multimode UE may perform a search for a signal—onto which it may camp and ultimately receive service—within a large number of possible, supported frequency bands for each of a large number of possible, supported modes, which also may be referred to as radio access technologies (RAT). Because a multiband/multimode UE may search through a large number of supported frequency bands in each of a large number of RATs, it may take a long amount of time before the UE identifies an acceptable signal and acquires service. A multiband/multimode UE may perform a similar procedure upon entering a roaming state, e.g., a state in which the UE can no longer access a frequency band and/or RAT associated with its default, or preferred, setting and/or its most recent access.

More particularly, a UE may perform a search for an acceptable signal by scanning within a first RAT. The UE may identify what seems like an acceptable signal during the scan; however, the identified signal may actually be associated with a RAT that is different from the first RAT. As such, the UE will not ultimately be able to acquire service through the identified signal, but will likely waste time attempting to do so. In addition, even though the identified signal was not ultimately useful during the current scan, it may provide the UE with a hint as to signals that may exist, and on to which the UE may successfully camp, within other RATs. However, a conventional UE has no way of using such potentially useful information.

As such, improvements in attempts to acquire service by a multiband and/or multimode UE are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method of frequency scanning for wireless communication is described. The method may include selecting a first radio access technology associated with multiple frequency bands. The method may include selecting a first frequency band from among the multiple frequency bands. The method may include performing a first signal scan associated with the first radio access technology in the first frequency band. The method may include identifying at least one candidate signal in the first frequency band. The method may include signaling a false alarm by determining that the at least one candidate signal is not associated with the first radio access technology. The method may include storing candidate signal information as false alarm information related to the at least one candidate signal. The method may include selecting a second radio access technology associated with at least one of the multiple frequency bands. The method may include selecting a second frequency band from among the at least one of the multiple frequency bands based on the stored false alarm information. The method may include performing a second signal scan associated with the second radio access technology in the second frequency band.

In an aspect, a non-transitory computer-readable medium for frequency scanning for wireless communication comprising code is described. The code, when executed by a processor or processing system included within a user equipment, may cause the user equipment to select a first radio access technology associated with multiple frequency bands. The code, when executed by a processor or processing system included within a user equipment, may cause the user equipment to select a first frequency band from among the multiple frequency bands. The code, when executed by a processor or processing system included within a user equipment, may cause the user equipment to perform a first signal scan associated with the first radio access technology in the first frequency band. The code, when executed by a processor or processing system included within a user equipment, may cause the user equipment to identify at least one candidate signal in the first frequency band. The code, when executed by a processor or processing system included within a user equipment, may cause the user equipment to signal a false alarm by determining that the at least one candidate signal is not associated with the first radio access technology. The code, when executed by a processor or processing system included within a user equipment, may cause the user equipment to store candidate signal information as false alarm information. The code, when executed by a processor or processing system included within a user equipment, may cause the user equipment to select a second radio access technology associated with at least one of the multiple frequency bands. The code, when executed by a processor or processing system included within a user equipment, may cause the user equipment to select a second frequency band from among the at least one of the multiple frequency bands based on the stored false alarm information. The code, when executed by a processor or processing system included within a user equipment, may cause the user equipment to perform a second signal scan associated with the second radio access technology in the second frequency band.

In an aspect, an apparatus for frequency scanning for wireless communication is described. The apparatus may include means for selecting a first radio access technology associated with multiple frequency bands. The apparatus may include means for selecting a first frequency band from among the multiple frequency bands. The apparatus may include means for performing a first signal scan associated with the first radio access technology in the first frequency band. The apparatus may include means for identifying at least one candidate signal in the first frequency band. The apparatus may include means for signaling a false alarm by determining that the at least one candidate signal is not associated with the first radio access technology. The apparatus may include means for storing information related to the at least one candidate signal. The apparatus may include means for selecting a second radio access technology associated with at least one of the multiple frequency bands. The apparatus may include means for selecting a second frequency band from among the at least one of the multiple frequency bands based on the stored false alarm information. The apparatus may include means for performing a second signal scan associated with the second radio access technology in the second frequency band.

In an aspect, an apparatus for frequency scanning for wireless communication is described. The apparatus may include a mode module configured to select a first radio access technology associated with multiple frequency bands. The apparatus may include a band module configured to select a first frequency band from among the multiple frequency bands. The apparatus may include a scanner module configured to perform a first signal scan associated with the first radio access technology in the first frequency band. The apparatus may include a false alarm detector module configured to identify at least one candidate signal in the first frequency band, signal a false alarm by determining that the at least one candidate signal is not associated with the first radio access technology, and store candidate signal information as false alarm information. The mode module may be further configured to select a second radio access technology associated with at least one of the multiple frequency bands. The band module may be further configured to select a second frequency band from among the at least one of the multiple frequency bands based on the stored false alarm information. The scanner module may be further configured to perform a second signal scan associated with the second radio access technology in the second frequency band.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a wireless communication system having aspects configured for efficient radio access technology (RAT) frequency scanning based on false alarms;

FIG. 2 is flow chart of a method for radio access technology (RAT) frequency scanning according to the present aspects;

FIG. 3 is a flow chart of a method for efficient radio access technology (RAT) frequency scanning based on false alarms according to the present aspects;

FIG. 4 is a block diagram illustrating an example of a hardware implementation for an apparatus employing a processing system and having aspects configured for efficient radio access technology frequency scanning based on false alarms;

FIG. 5 is a block diagram illustrating an example of a telecommunications system having aspects configured for efficient radio access technology frequency scanning based on false alarms;

FIG. 6 is a block diagram illustrating an example of an access network having aspects configured for efficient radio access technology frequency scanning based on false alarms;

FIG. 7 is a block diagram illustrating an example of a radio protocol architecture for a user and control plane, which may be used by a user equipment, having aspects configured for efficient radio access technology frequency scanning based on false alarms, to communicate with a Node B; and

FIG. 8 is a block diagram illustrating an example of a Node B in communication with a UE in a telecommunications system having aspects configured for efficient radio access technology frequency scanning based on false alarms.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. Mobile devices or user equipment (UE) may be compatible with more than one form of data transmission or network. A multiple band (also referred to as “multi-band” or “multiband”) UE may have multi-band capability, such that it can switch radio frequencies, which may be described in terms of Megahertz (MHz). For example, a dual-band TDMA UE may use TDMA services in either an 800 MHz or a 1900 MHz system. For GSM, a dual-band UE may be able to access 850 MHz and 1900 MHz radio frequency bands (which are used in the United States and Canada), and 900 MHz and 1800 MHz radio frequency bands (which are used in Europe and many other countries). A tri-band GSM UE may be able to access 850 MHz, 1800 MHz, and 1900 MHz radio frequency bands or 900 MHz, 1800 MHz, and 1900 MHz radio frequency bands. A quad-band GSM UE may be able to access 850 MHz, 900 MHz, 1800 MHz, and 1900 MHz radio frequency bands.

A multiple mode (also referred to as “multi-mode” or “multimode”) UE may support more than one radio access technology (RAT). A RAT also may be referred to as a transmission type, mode, network, and/or standard. Examples of RATs include, but are not limited to, WCDMA, TDMA, GSM, LTE, and/or an analog mode. A RAT may be a narrowband RAT (e.g., GSM) or a wideband RAT (e.g., WCDMA). For instance, a UE that supports two RATs may be referred to as a dual-mode UE; while a UE that supports two digital RATs and analog transmissions may be referred to as a tri-mode UE.

Further, a UE may support both multiple bands and multiple modes, such that the UE may be configured to be able to switch between frequency bands and RATs. For UEs that support these options, frequency bands and/or RATs may be switched automatically. In an aspect, such a UE may have a default setting (e.g., 800 MHz TDMA) that it may use before attempting to connect to a different frequency band (e.g., 1900 MHz TDMA) and/or RAT (e.g., GSM or analog). Multi-band UEs may enable roaming outside of a default, or preferred, setting (e.g., frequency band and RAT) associated with the UE. Such a default or preferred setting may be based on, for example, a geographic location where a UE is normally located and/or used, a factory-default setting, a wireless service provider setting, and/or information configured by a user of the UE. Some aspects of a multimode/multiband UE may be referred to as a “world phone” since it can theoretically receive service on any network (e.g., RAT) and any frequency band associated with each network anywhere in the world.

In a conventional system, upon powering up, a multiband/multimode UE may perform a search for a signal—onto which it may camp and ultimately receive service—within a large number of possible, supported frequency bands for each of a large number of possible, supported modes. Because the number of supported frequency bands and RATs may be rather large for a multiband/multimode UE, it may take an unacceptably long amount of time for the UE to scan all supported frequency bands in all supported RATs before the UE finds an acceptable signal and acquires service. A multiband/multimode UE may perform a similar procedure upon entering a roaming state, e.g., a state in which the UE can no longer access a frequency band and/or RAT associated with its default, or preferred, setting and/or its most recent access.

In a particular, non-limiting example, a multimode/multiband UE may be a cellular phone associated with a wireless service provider (e.g., AT&T) in the United States, in which WCDMA operates on the 850 MHz frequency band (also having Band V and downlink (DL) frequency 869-894 MHz). Assume that the UE in the example determines to acquire a signal. For example, the UE may be powering up or enter a roaming state (e.g., moves out of range of the AT&T service) such that the UE is located in a geographic area where there is no WCDMA service, but there is GSM service on the 850 MHz frequency band. The UE in the example will first attempt to acquire a signal associated with its associated wireless service: WCDMA in the 850 MHz frequency band. As such, the UE in the example will perform a frequency search, or scan, for a candidate WCDMA signal in the 850 MHz frequency band. In this example, the UE detects a candidate signal (e.g., a signal having a strength above a given threshold and onto which the UE may potentially camp) associated with the GSM network in the 850 MHz frequency band. Because the UE is currently operating, and scanning, within the WCDMA mode, the UE will not be able to camp on the (GSM) candidate signal no matter how strong it is. Therefore, the detection of the candidate signal will be a false alarm.

The UE in this example may determine that the candidate signal is not associated with WCDMA (e.g., is associated with GSM) by comparing a band type of the candidate signal (e.g., narrowband or wideband) with a band type associated with the RAT (e.g., WCDMA) in which the UE is currently operating and scanning. The term narrowband may be used to describe a channel in which the bandwidth of a message being sent on the channel does not significantly exceed the coherence bandwidth of the channel. In contrast, the term wideband may be used to describe a channel in which the bandwidth of a message being sent on the channel does significantly exceed the coherence bandwidth of the channel. Coherence bandwidth is a statistical measurement of a range of frequencies over which a channel may be considered “flat”, or, in other words, an approximate maximum bandwidth or frequency interval over which two frequencies of a signal are likely to experience comparable or correlated amplitude fading. It can be reasonably assumed that a channel is flat if the coherence bandwidth is greater than the data signal bandwidth of the channel. As such, and for example, a narrowband channel may be sufficiently narrow that it may be virtually flat. In an aspect, a UE may determine if a signal is associated with a band type of narrowband or wideband by using a narrowband filtering algorithm (e.g., which will filter narrowband, or flat, modes, such as GSM) and/or a wideband (e.g. WCDMA) code space search.

Although it may be undesirable for a UE to identify a candidate signal onto which it will ultimately not be able to camp—because, for example, the candidate signal is associated with a RAT that is different from the RAT in which the UE is currently operating and scanning—the detection of such a false alarm may be useful to the UE during later scanning of another RAT. For example, information related to the candidate signal (e.g., false alarm information) may be useful to the UE when it is scanning for a candidate signal within a different RAT. In the above example, upon completing the WCDMA scan (e.g., scanning for a WCDMA signal in all of the frequency bands associated with WCDMA) the UE may attempt to scan within a different RAT for a candidate signal.

However, if the UE is aware of information associated with previously-detected candidate signals that were determined to be false alarms, the UE may use that information to attempt to find an acceptable signal on which to camp as quickly as possible, e.g., within the next scan. For example, a UE may store candidate signal information, including a frequency (f) of the candidate signal, frequency band (B) in which the candidate signal was identified, a power level (P) of the candidate signal, and/or additional criteria, as false alarm information. Upon selecting a next mode or RAT for its next scan, the UE may access such false alarm information to determine a RAT that is more likely to include an acceptable signal than other supported RATs. In the present example, the UE may retrieve false alarm information for the candidate signal found within GSM in the 850 MHz frequency band. In response to this information, the UE may select GSM for its next scan and start with the list of narrowband candidate frequencies obtained during the WCDMA frequency scan (e.g., in the 850 MHz frequency band). In the example, the UE may quickly (again) find the candidate signal and, in this case, determine that the candidate signal is of the same band type (e.g., narrowband) as the RAT in which the UE is currently operating and scanning (e.g., GSM, narrowband). As such, the UE may successfully camp on the candidate signal.

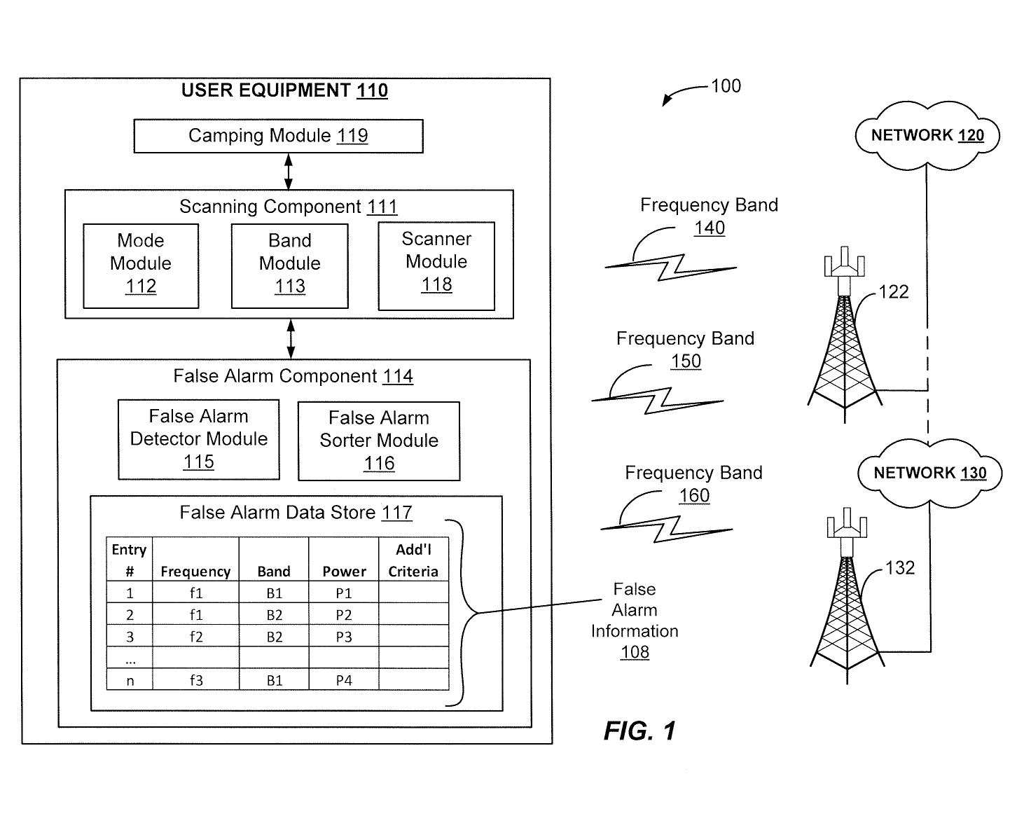

Referring to FIG. 1, a UE 110 is in communication with network 120 and network 130, via base stations 122 and 132, respectively, within wireless communications system 100. In an aspect, UE 110 may be multimode- and multiband-capable. However, it may be understood that aspects of the present disclosure may also be advantageous for a UE that is multimode- or multiband-capable.

Base station 122 and/or base station 132, which also may be referred to as an access point or node, may be a macrocell, picocell, femtocell, relay, Node B, mobile Node B, UE (e.g., communicating in peer-to-peer or ad-hoc mode with UE 110), or substantially any type of component that can communicate with UE 110 to provide wireless network access.

UE 110 also may be referred to as a mobile apparatus, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

Networks 120 and 130 represent different radio access technologies (RAT) or modes having different frequency band types. In a non-limiting example, one of networks 120 and 130 may be a narrowband mode (e.g., GSM/1X) and one may be a wideband mode (e.g., WCDMA or LTE). UE 110 may communicate with networks 120 and 130 via different frequency bands: frequency band 140, frequency band 150, and/or frequency band 160. Frequency bands 140, 150, and 160 may overlap with one another such that one of frequency bands 140, 150, and/or 160 is available for communication between the UE 110 and both network 120 and network 130.

UE 110 may include scanning component 111 configured to scan multiple RATs in multiple frequencies in order to acquire a signal. UE 110 may perform a scan upon powering up, upon entering a roaming state, and/or during any other time or condition when UE 110 is in need of acquiring wireless service (e.g., a current serving cell of UE 110 has a signal strength that falls below a given threshold, such as a threshold below which support for serving a call is deemed unreliable or lacking sufficient quality). Scanning component 111 may include mode module 112 configured to select a RAT or mode for a particular scan and band module 113 configured to select a frequency band within a selected RAT or mode for a particular scan. Scanning component 111 also may include scanner module 118 configured to perform the frequency scan (for a particular mode and frequency band determined by mode module 112 and band module 113, respectively). The frequency scan performed by scanning component 111 may seek to identify a candidate, or strong, signal (e.g., a signal having a signal strength greater than a given threshold, such as a threshold deemed strong enough to reliably support communication, where in some aspects the threshold may include a hysteresis value to increase the threshold to avoid easily switching from a current serving cell and thereby avoiding a ping-pong effect) onto which UE 110 may hopefully camp and acquire service.

UE 110 also may include false alarm component 114 configured to detect, store, and/or sort candidate signal information as false alarm information 108 corresponding to candidate signals that are determined to be false alarms. A false alarm may occur when, while scanning in a particular frequency band, UE 110 detects a signal from a RAT that is not suitable for obtaining service (e.g., has a different band type) from the RAT in which UE 110 is currently scanning for a signal. False alarm component 114 includes false alarm detector module 115, which may be configured to detect a false alarm during a scan by determining that a candidate signal in the frequency band associated with the current scan is not associated with the RAT in which the UE 110 is currently scanning for a signal. In an aspect, false alarm detector module 115 may be configured to communicate with scanner module 118 to receive false alarm information 108 about candidate signals detected during a previous scan. In an aspect, false alarm detector module 115 may monitor scans performed by scanner module 118, may periodically receive false alarm information 108 associated with a current scan from scanner module 118 during or after the scan, and/or may periodically request false alarm information 108 associated with a current or past scan from scanner module 118 during or after a scan.

In an aspect, false alarm detector module 115 may determine that the candidate signal is associated with a different band type than a band type associated with the current RAT. For example, the current RAT may be a wideband technology (e.g., WCDMA) and the candidate signal may be associated with a narrowband technology (e.g., GSM). In an aspect, a UE may determine if a signal is associated with a band type of narrowband or wideband by using a narrowband filtering algorithm (e.g., which will filter narrowband, or flat, modes, such as GSM) and/or a wideband (e.g., WCDMA) code space search.

More particularly, and for example, while performing a frequency scan in a RAT, the UE may come across signals that are spread across a wideband (e.g., 5 MHz or more). Such signals may be false alarms for the current RAT and, as such, may be classified as candidate signals for a wideband (e.g., LTE) frequency scan. In another example, while performing a frequency scan in a RAT, the UE may encounter signals that have a significant power level (e.g., are strong signals) but are spread across a very narrowband (e.g., 200 KHz). Such signals may be false alarms for the current RAT, and, as such, may be classified as candidate signals for a narrowband (e.g., GSM) frequency scan.

Based on determining that the candidate signal and the current RAT are not of the same band type (e.g., the candidate signal is associated with a different RAT than the current RAT), false alarm detector module 115 may be configured to collect information related to the candidate signal, such as, for example, the frequency (f) of the candidate signal, the frequency band (B) in which the candidate signal was detected, a power level (P) of the candidate signal, and/or the like, and store it as false alarm information 108 within false alarm data store 117.

False alarm component 114 may include false alarm data store 117 configured to store false alarm information 108 associated with candidate signals that were determined to be false alarms detected by false alarm detector module 115. False alarm data store 117 may include a database, or other component suitable for storing correlated data, having an entry for each false alarm (which may be, in a non-limiting example, assigned an identification number—shown as 1, 2, 3, . . . , n in FIG. 1). Within each false alarm entry, a frequency (f), band type (B) (e.g., narrowband or wideband), power level (P), and any additional criteria may be recorded based on the information collected by false alarm detector module 115. In an aspect, false alarm data store 117 is a unified data store that is common, and accessible, to UE 110 across modes or RATs.

False alarm component 114 may include false alarm sorter module 116 configured to sort false alarm information 108, associated with candidate signals that were determined to be false alarms, as stored in false alarm data store 117. In an aspect, false alarm information may be sorted, and prioritized, based on at least one of the categories of information stored in connection with each false alarm entry, such as, for example, frequency (f), band (B), and/or power level (P). In a particular, non-limiting example, false alarm sorter module 116 may sort candidate signals by their associated power levels (P) such that the false alarm entries within false alarm data store 117 are organized by power level (P) in decreasing order.

In an aspect, false alarm sorter module 116 may be configured to communicate with false alarm detector module 115 to receive false alarm information 108 as false alarms are detected (e.g., within a certain amount of time after a false alarm is detected) and sort (and re-sort) entries within false alarm data store 117 as the false alarm information 108 is updated and stored. For example, false alarm detector module 115 may signal a particular false alarm and may notify false alarm sorter module 116 of the particular false alarm. False alarm sorter module 116 may be configured to identify a location where a candidate signal associated with the particular false alarm may fall within the previously-sorted and stored entries within false alarm data store 117, and store the particular false alarm entry accordingly.

In an aspect, false alarm sorter module 116 may be configured to sort all entries of false alarm information 108 that have been stored within false alarm data store 117 upon completion of a scan. A scan may be considered complete when a single frequency for a RAT has been scanned, all possible frequencies for a RAT have been scanned, and/or based on some other criteria.

In an aspect, false alarm sorter module 116 may be configured to sort entries of false alarm information 108 that have been stored within false alarm data store 117 upon initiation of a signal scan when the current signal scan is not the first signal scan. In other words, false alarm sorter module 116 may be configured to determine whether any false alarm information 108 has been previously-stored within false alarm data store 117 upon a determination by scanning component 111 to initiate a scan, and, if so, sort the false alarm entries of false alarm information 108 before commencement of the scan.

Upon determination by UE 110 that it is to acquire a signal, mode module 112 may be further configured to select a first RAT (or mode) for a first scan. Mode module 112 may be configured to select the first RAT based on a UE default setting, a user input (e.g., an existing user preference, a new user input, or the like), a determination of a current geographic location, and/or a setting or input from a wireless service provider associated with the UE 110. Mode module 112 may be configured to communicate the selected first RAT to band module 113. In response, band module 113 may communicate with false alarm component 114 to determine if any false alarm information 108 is currently stored within false alarm data store 117. If not, band module 113 may select a first frequency band associated with the first RAT without any additional input.

If false alarm information 108 has been previously-stored within false alarm data store 117, false alarm component 114 may communicate such false alarm information 108 to band module 113. In an aspect, in its request for information about previously-stored false alarm information 108, band module 113 may communicate the currently-selected first RAT to false alarm component 114. In response, false alarm sorter module 116, may be configured to select a prioritization scheme—associated with various attributes of the first RAT (e.g., whether specific false alarm information is more important and/or valuable when scanning the first RAT)—and sort and/or prioritize the entries of false alarm information 108 based on the selected scheme (if such sorting has not already been performed).

False alarm component 114 may be configured to provide the sorted false alarm information 108 to band module 113. Band module 113 may be configured to determine a frequency band, from among the frequency bands (B) associated with the previously-stored false alarm information 108, which has the highest priority among the false alarms. For example, the false alarm information 108 may be sorted by power level (P) in decreasing order such that a false alarm associated with a candidate signal having the highest power level (P) may be the highest priority false alarm. Band module 113 may select the frequency band associated with the highest priority false alarm to use as the first frequency band in which to scan for candidate signals associated with the first RAT.

In any event, mode module 112 and band module 113 may be configured to communicate the selected RAT and selected frequency band, respectively, to scanner module 118. Scanner module 118 may be configured to commence the scan based on the selected RAT and selected frequency band. While performing the scan, scanner module 118 may identify a target signal in the selected frequency band and determine that the target signal is associated with the selected RAT and that the target signal is not a false alarm.

UE 110 also may include camping module 119 configured to receive information from scanner module 118 related to the identified target signal associated with the selected RAT and selected frequency band. In response, camping module 119 may be configured to determine that the target signal is suitable for camping and cause UE 110 to camp on the target signal.

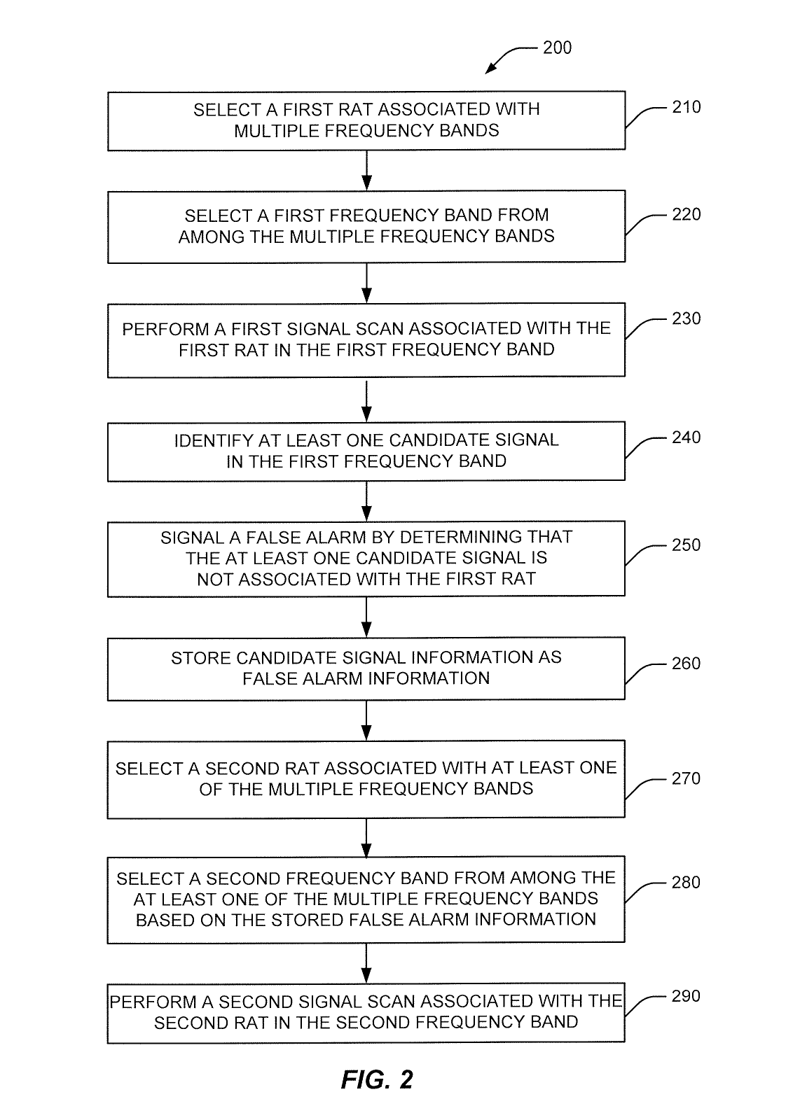

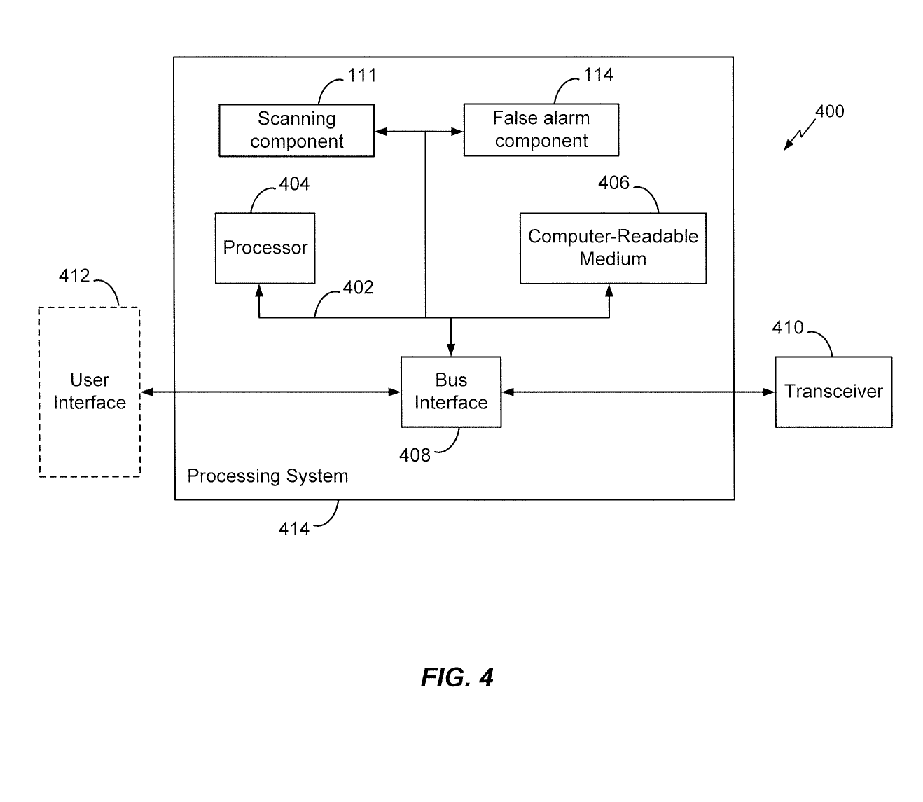

In an aspect, scanning component 111, mode module 112, band module 113, scanner module 118, false alarm component 114, false alarm detector module 115, false alarm sorter module 116, false alarm data store 117, and/or camping module 119 may be hardware components physically included within UE 110. In another aspect, scanning component 111, mode module 112, band module 113, scanner module 118, false alarm component 114, false alarm detector module 115, false alarm sorter module 116, false alarm data store 117, and/or camping module 119 may be software components (e.g., software modules), such that the functionality described with respect to each of the components and modules may be performed by a specially-configured computer, processor (or group of processors), and/or a processing system (e.g., processor 404 of FIG. 4), included within UE 110, executing one or more of the modules. Further, and in an aspect where the components and modules of UE 110 are software modules, the software modules may be downloaded to UE 110 from, e.g., a server or other network entity, retrieved from a memory or other data store internal to UE 110 (e.g., computer-readable medium 406 of FIG. 4), and/or accessed via an external computer-readable medium (e.g., a CD-ROM, flash drive, and/or the like). Referring to FIG. 2, UE 110 may use a method 200 for efficient radio access technology (RAT) frequency scanning based on false alarms according to aspects of the present disclosure. More particularly, UE 110 may use method 200 for improving frequency scanning associated with a RAT based on false alarms detected during previous frequency scanning associated with a different RAT. Aspects of the method 200 may be performed by scanning component 111, mode module 112, band module 113, scanner module 118, false alarm component 114, false alarm detector module 115, false alarm sorter module 116, false alarm data store 117, and/or camping module 119 within UE 110 of FIG. 1.

At 210, the method 200 includes selecting a first radio access technology associated with multiple frequency bands. Mode module 112 may be configured to select a first RAT (RAT₀) associated with multiple frequency bands. The multiple frequency bands for a particular RAT may be referred to as B_{RAT} and the multiple frequencies within a frequency band may be referred to as fₙ. As such, B_{RAT}=[B_{RAT}_{_{—}}₀, B_{RAT}_{_{—}}1, . . . , B_{RAT}_{_{—}}_{N}] and B_{RAT}_{_{—}}ₙ=[f₀, f₁, . . . , f_{N}]. The multiple frequency bands (B_{RAT}) may be all bands that are supported for the particular RAT.

In an aspect, selecting a first RAT associated with multiple frequency bands may include selecting the first RAT based on at least one of a default setting, a user input, a determination of a current geographic location, and/or a wireless service provider input or setting.

At 220, the method 200 includes selecting a first frequency band from among the multiple frequency bands. Band module 113 may be configured to select a first frequency band (B_{RAT}_{_{—}}₀) from among the multiple frequency bands B_{RAT} associated with the selected RAT.

At 230, the method 200 includes performing a first signal scan associated with the first radio access technology in the first frequency band. Scanner module 118 may be configured to perform a first signal scan associated with the first RAT (RAT₀) in the first frequency band (B_{RAT}_{_{—}}₀).

At 240, the method 200 includes identifying at least one candidate signal in the first frequency band. Scanner module 118 may be configured to identify at least one candidate signal in the first frequency band (B_{RAT}_{_{—}}₀). A candidate signal may be a signal which may, in an aspect, have a power level (P) above a certain threshold power level. Scanner module 118 may be configured to communicate candidate signal information (e.g., frequency (f), band (B), power level (P) and/or the like) related to identified candidate signals to false alarm detector module 115, in any one of a variety of ways, to determine if the candidate signal is a false alarm.

At 250, the method 200 includes signaling a false alarm by determining that the at least one candidate signal is not associated with the first radio access technology. False alarm detector module 115 may be configured to determine that the at least one candidate signal is not associated with the first RAT (RAT₀) and, as such, signal a false alarm.

In an aspect, the first RAT may be associated with a first band type, such that the false alarm detector module 115 may be configured to signal a false alarm by determining that the at least one candidate signal is associated with a second band type that is different from the first band type associated with the first RAT. The first band type and second band type may be narrowband (e.g., GSM) or wideband (e.g., WCDMA). The false alarm detector module 115 may be configured to determine that the detected candidate signal is not associated with the selected RAT (e.g., is of a different band type) as described herein.

At 260, the method 200 includes storing candidate signal information as false alarm information. False alarm detector module 115 may be configured to store candidate signal information related to the at least one candidate signal including, for example, frequency (f), band type (B) (e.g., narrowband or wideband), power level (P) and/or the like, as false alarm information 108 in false alarm data store 117.

In an aspect, false alarm sorter module 116 may be configured to sort the false alarm information 108 (e.g., information related to the at least one candidate signal) included in false alarm data store 117 based on at least one of the frequency (f), band type (B) and power level (P). In an aspect, false alarm sorter module 116 may be configured to sort the false alarm information 108 in decreasing order of power level (P) associated with each of the at least one candidate signal in each false alarm entry.

In an aspect, false alarm sorter module 116 may be configured to sort the false alarm information 108 by determining a proper place for a new false alarm entry among previously-stored false alarm entries within the false alarm data store 117 database and storing the new false alarm information 108 accordingly. In another aspect, false alarm sorter module 116 may be configured to sort the information in false alarm data store 117 at another time.

In an aspect, storing candidate signal information may include determining that the at least one candidate signal has a power level above a threshold power value and storing the candidate signal information. In an aspect, if a candidate signal does not have a power level above a threshold power value, false alarm detector module 115 may be configured to not store (e.g., discard) the candidate signal information as false alarm information 108 in the false alarm data store 117.

At 270, the method 200 includes selecting a second radio access technology associated with at least one of the multiple frequency bands. Mode module 112 may be configured to select a second RAT (RAT₁) associated with at least one of the multiple frequency bands (B_{RAT}). In an aspect, different RATs (e.g., RAT₀ and RAT₁) may be configured to support the same frequency band. In other words, a particular frequency band may overlap between two different RATs. Thus, a second RAT (e.g., RAT_{I}) may be selected having at least one frequency band (e.g., B_{RAT}_{_{—}}₀) in common with the first RAT (e.g., RAT₀).

At 280, the method 200 includes selecting a second frequency band from among the at least one of the multiple frequency bands based on the stored false alarm information. Band module 113 may be configured to select a second frequency band (B_{RAT}_{_{—}}₀) from among the at least one of the multiple frequency bands (B_{RAT}) based on the stored false alarm information 108. In an aspect, selecting a second frequency band may include selecting a prioritization scheme based on the second RAT. In a non-limiting example, a higher frequency (f) may be more important than a higher power level (P) when scanning within a particular RAT, and, as such, false alarm sorter module 116 may be configured, in an aspect, to sort the stored false alarm information 108 from highest to lowest frequency (f) values associated with the candidate signals stored as false alarm information 108 when the UE 110 is preparing to scan within the particular RAT. In an aspect, selecting a second frequency band also may include prioritizing individual false alarms, each of which is associated with a candidate signal, within the stored false alarm information 108 based on the selected prioritization scheme, and retrieve the prioritized false alarm information 108. As such, selecting of the second frequency band may include selecting a frequency band associated with the at least one candidate signal having a highest priority based on the prioritizing. In an aspect, band module 113 may be in communication with false alarm sorter module 116 to determine whether previously-stored, and sorted, false alarm information 108 includes one or more frequencies associated with the selected second RAT (RAT₁). If so, band module 113 may determine a frequency (f) having a highest priority, which may, in an aspect, be a frequency associated with a candidate signal within a false alarm entry having a highest power level (P) among the previously-stored false alarm information 108. In order to improve the likelihood of quickly finding a frequency associated with the second selected RAT (RAT₁) that is suitable for camping, the band module 113 may select the frequency having the highest priority as the second frequency band (B_{RAT}_{_{—}}₀) to be scanned in connection with the second selected RAT (RAT₁) by scanner module 118.

At 290, the method 200 includes performing a second signal scan associated with the second radio access technology in the second frequency band. Scanner module 118 may be configured to perform a second signal search associated with the second RAT (e.g., RAT₁) and the second frequency band (e.g., B_{RAT}_{_{—}}₀).

In an optional aspect (not shown), the method 200 may include identifying a target signal in the second frequency band, determining that the target signal is associated with the second radio access technology, determining that the target signal is suitable for camping, and camping on the target signal. Scanner module 118 may be configured to identify a target signal in the second frequency band (e.g., B_{RAT}_{_{—}}₀) and determine that the target signal is associated with the second RAT (e.g., RAT₁). In response, camping module 119 may be configured to determine that the target signal is suitable for camping and camp on the target signal. In an aspect, determining that the target signal is associated with the second RAT may include determining that the target signal is associated with a band type that is the same as a band type associated with the second RAT as described herein. In other words, the target signal is not a false alarm.

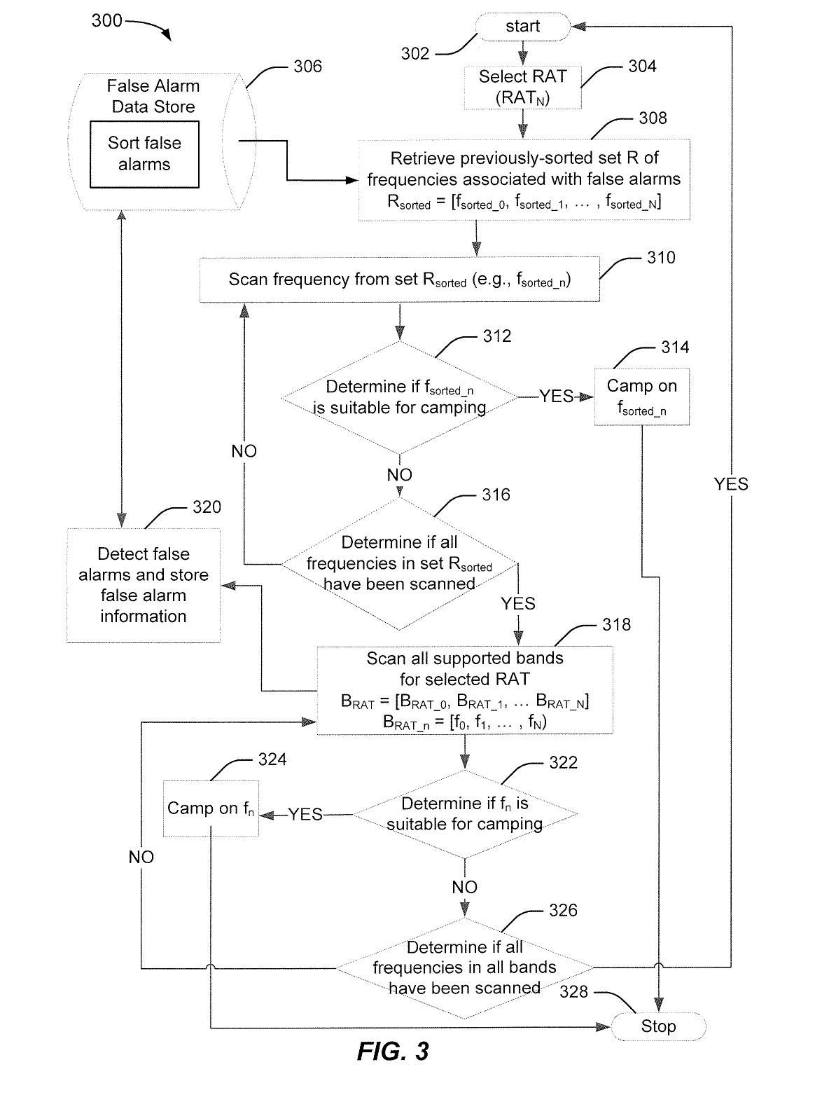

Referring to FIG. 3, UE 110 may use a method 300 to acquire a signal associated with a particular radio access technology (RAT) by frequency scanning according to aspects of the present disclosure is shown. Aspects of the method 300 may be performed by scanning component 111 and false alarm component 114, both within UE 110, of FIG. 1. Method 300 may include more detailed information in a non-limiting example, for aspects of method 200 of FIG. 2.

At 302, the method 300 starts when, in an aspect, UE 110 determines to acquire a signal. UE 110 may determine to acquire a signal upon power up, upon entering a roaming state, or at some other time when UE 110 seeks to acquire wireless service.

At 304, the method 300 includes selecting a radio access technology (RAT). Mode module 112 may select a first RAT (RAT₀) for the current frequency scan initiated at 302. The complete set of RATs for which the UE 110 is configured may be referred to as RATₙ, where RATₙ=[RAT₀, RAT₁, . . . RAT_{N}].

At 308, the method 300 includes retrieving a previously-sorted set (R_{sorted}) of frequencies associated with false alarm information 108, where R_{sorted}=[f_{sorted}_{_{—}}₀, f_{sorted}_{_{—}}₁, . . . , f_{sorted}_{_{—}}_{N}]. Scanning component 111 may be configured to notify false alarm component 114 that a scan has been initiated for the selected RAT. In response, false alarm component 114 may be configured to determine whether false alarm information 108 has been previously-stored in false alarm data store 117 as a result of false alarms being detected during a previous scan for a different RAT. If not, the method will move to action 318 (connection not shown).

If false alarm component 114 determines that false alarm information 108 is currently stored in false alarm data store 117, false alarm component 114 may be configured to retrieve the false alarm information 108, at 308. In an aspect, false alarm sorter module 116 may be configured to sort and/or prioritize the false alarm information 108 retrieved from false alarm data store 117. In an aspect, false alarm sorter module 116 may be configured to prioritize the false alarm information 108 based on a prioritization scheme associated with the selected RAT for the current scan, such that false alarm information 108 may be prioritized differently for different RATs. For example, false alarm sorter module 116 may prioritize the false alarm information 108 in decreasing order by power level (P) of a candidate signal associated with each false alarm entry in false alarm information 108 in descending order. As such, the false alarm associated with a candidate signal having the highest power level (P) may have the highest priority. False alarm component 114 may be configured to provide the sorted and prioritized false alarm information 108 to band module 113. The returned sorted false alarm information 108 may be defined as a set of frequencies (0 (e.g., frequencies associated with a candidate signal per false alarm entry) R_{sorted}=[f_{sorted}_{_{—}}₀, f_{sorted}_{_{—}}₁, . . . , f_{sorted}_{_{—}}_{N}].

At 310, the method 300 includes scanning a frequency (f_{sorted}_{_{—}}ₙ) from the set R_{sorted}. Band module 113 may be configured to select a first frequency to scan for the selected RAT based on the frequencies included in the set R_{sorted}, which may be referred to as f_{sorted}_{_{—}}ₙ (e.g., f_{sorted}_{_{—}}ₙ=f_{sorted}_{_{—}}₀). In an aspect, band module 113 may be configured to select, as a first frequency, the frequency associated with the previously-stored false alarm entry in false alarm information 108 having the highest priority. In this way, scanner module 118 may first scan a frequency where a candidate signal with a high power level (P) that was determined to be a false alarm was previously detected. As such, it is likely that such a signal, which is suitable for camping and is associated with the RAT, will be found in a shorter period of time than would be required if scanner module 118 simply scanned frequencies within a RAT in no particular order, or in a previously-set order (as shown at 318, and which may be done if no previously-stored false alarm information 108 is available for a particular scan and/or scanning according to previously-stored false alarm information 108 does not yield a frequency that is suitable for camping).

At 312, the method 300 includes determining if f_{sorted}_{_{—}}ₙ is suitable for camping. False alarm detector module 115 may be configured to determine if fₛₒᵣₜₑ_{_{—}}ₙ is suitable for camping. In an aspect, false alarm detector module 115 may be configured to determine whether the particular frequency f_{sorted}_{_{—}}ₙ has the same band type as the selected RAT by performing a narrowband (e.g., GSM) filtering algorithm and/or a wideband (e.g., WCDMA) code space searching algorithm as described herein. In a non-limiting example, if the selected RAT is GSM, which is a narrowband technology, and the particular frequency f_{sorted}_{_{—}}ₙ is also narrowband (e.g., GSM), the particular frequency f_{sorted}_{_{—}}ₙ may be determined to be not a false alarm and, as such, suitable for camping.

At 314, if f_{sorted}_{_{—}}ₙ is suitable for camping, the method 300 includes camping on f_{sorted}_{_{—}}ₙ. Camping module 119 may be configured to cause UE 110 to camp on f_{sorted}_{_{—}}ₙ. The method 300 then ends at 328.

At 316, if f_{sorted}_{_{—}}ₙ is not suitable for camping, the method 300 includes determining if all frequencies in the set R_{sorted} have been scanned. Band module 113 in communication with scanner module 118 may be configured to determine whether all frequencies in the set R_{sorted} have been scanned. In other words, the method 300 includes determining if the current frequency (fₙ) is the last frequency in the set (e.g., f_{sorted}_{_{—}}ₙ=f_{sorted}_{_{—}}_{N}). If not, the method 300 returns to action 310 and the next frequency within the set R_{sorted} (e.g., f_{sorted}_{_{—}}ₙ=f_{sorted}_{_{—}}₁) is selected for scanning.

At 318, if all frequencies in the set have been scanned R_{sorted} (e.g., f_{sorted}_{_{—}}ₙ=f_{sorted}_{_{—}}_{N}), the method 300 includes scanning all supported bands (B) for the selected RAT, where B_{RAT}=[B_{RAT}_{_{—}}₀, B_{RAT}_{_{—}}₁, . . . B_{RAT}_{_{—}}_{N}] and B_{RAT}_{_{—}}ₙ=[f₀, f₁, . . . , f_{N}]. If band module 113 in communication with scanner module 118 determines that all of the frequencies associated with previously-stored false alarms have been scanned—and no frequency has been determined to be suitable for camping—scanner module 118 may be configured to scan all supported bands for the selected RAT by scanning through each frequency in each supported band one-by-one. The frequency bands may be selected in a random order, a preconfigured order, a user-configured order and/or some other criteria.

At 320, the method 300 includes detecting false alarms and storing false alarm information. In an aspect, false alarm detector module 115 may be configured to monitor the frequency scan performed by scanner module 118. In an aspect, false alarm detector module 115 may be configured to request and/or receive information from scanner module 118 regarding current and/or past scan(s). If a candidate signal is identified, false alarm detector module 115 may be configured to determine if the candidate signal is a false alarm (e.g., whether the candidate signal is, or is not, associated with the selected RAT). In an aspect, a false alarm may occur when a candidate signal is detected, but the signal is not associated with the selected RAT (e.g., the selected RAT is narrowband and the candidate signal is wideband). Once false alarm detector module 115 detects a false alarm, it may be configured to store candidate signal information (e.g., frequency (f), band type (B), power level (P), and/or the like) as false alarm information 108 in false alarm data store 117. The stored false alarm information 108 may be sorted, by false alarm sorter module 116, before storage, after completion of a particular scan, and/or at a later time.

At 322, the method 300 includes determining if fₙ is suitable for camping. False alarm detector module 115 may be configured to determine if fₙ is suitable for camping. In an aspect, false alarm detector module 115 may be configured to determine whether the particular frequency fₙ has the same band type as the selected RAT as described herein. In a non-limiting example, if the selected RAT is GSM, which is a narrowband technology, and the particular frequency fₙ is also narrowband (e.g., GSM), the particular frequency fₙ may be determined to be not a false alarm, and, as such, suitable for camping.

At 324, if fₙ is suitable for camping, the method 300 includes camping on fₙ. Campingmodule 119 may be configured to cause UE 110 to camp on fₙ. The method 300 then ends at 328.

At 326, if fᵣ, is not suitable for camping, the method 300 includes determining if all frequencies (fₙ) within each band (B_{RAT}) supported for the selected RAT have been scanned. Band module 113 in communication with scanner module 118 may be configured to determine whether all frequencies (fₙ) within each band (B_{RAT}) supported for the selected RAT have been scanned. In other words, the method 300 includes determining if the current frequency (fₙ) is the last frequency in a band (e.g., fₙ=f_{N}) and the current band B_{RAT}_{_{—}}ₙ is the last band in the set of bands (e.g., B_{RAT}_{_{—}}ₙ=B_{RAT}_{_{—}}_{N}). If not, the method 300 returns to action 318 and the next frequency in the current band or the first frequency in the next band is selected for scanning by band module 113 in communication with scanner module 118.

If camping module 119 determines that fₙ is not suitable for camping, the method 300 returns to start 302. If fᵣ, is not suitable for camping, camping module 119 may so inform scanning component 111, which may, in response, determine to initiate another frequency scan for a different selected RAT and the method 300 may begin anew.

FIG. 4 is a block diagram illustrating an example of a hardware implementation for an apparatus 400 employing a processing system 414 configured for efficient radio access technology frequency scanning based on false alarms. In an aspect, apparatus 400 may be UE 110 of FIG. 1, including scanning component 111, mode module 112, band module 113, scanner module 118, false alarm component 114, false alarm detector module 115, false alarm sorter module 116, false alarm data store 117, and camping module 119.

In this example, the processing system 414 may be implemented with a bus architecture, represented generally by the bus 402. The bus 402 may include any number of interconnecting buses and bridges depending on the specific application of the processing system 414 and the overall design constraints. The bus 402 links together various circuits including one or more processors, represented generally by the processor 404, computer-readable media, represented generally by the computer-readable medium 406, scanning component 111 and false alarm component 114, both of FIG. 1. The bus 402 may also link various other circuits such as timing sources, peripherals, voltage regulators, and power management circuits, which are well known in the art, and therefore, will not be described any further. A bus interface 408 provides an interface between the bus 402 and a transceiver 410. The transceiver 410 provides a means for communicating with various other apparatus over a transmission medium. Depending upon the nature of the apparatus, a user interface 412 (e.g., keypad, display, speaker, microphone, joystick) may also be provided.

The processor 404 is responsible for managing the bus 402 and general processing, including the execution of software stored on the computer-readable medium 406. The software, when executed by the processor 404, causes the processing system 414 to perform the various functions described herein for any particular apparatus. More particularly, and as described above with respect to FIG. 1, scanning component 111, mode module 112, band module 113, scanner module 118, false alarm component 114, false alarm detector module 115, false alarm sorter module 116, false alarm data store 117, and/or camping module 119 may be software components (e.g., software modules), such that the functionality described with respect to each of the components and modules may be performed by processor 404.

The computer-readable medium 406 may also be used for storing data that is manipulated by the processor 404 when executing software, such as, for example, software modules represented by scanning component 111, mode module 112, band module 113, scanner module 118, false alarm component 114, false alarm detector module 115, false alarm sorter module 116, false alarm data store 117, and camping module 119. In one example, the software modules (e.g., any algorithms or functions that may be executed by processor 404 to perform the described functionality) and/or data used therewith (e.g., inputs, parameters, variables, and/or the like) may be retrieved from computer-readable medium 406. Further, false alarm data store 117 may be included within, or in communication with, computer-readable medium 406.

More particularly, the processing system further includes at least one of scanning component 111, mode module 112, band module 113, scanner module 118, false alarm component 114, false alarm detector module 115, false alarm sorter module 116, false alarm data store 117, and camping module 119. The components and modules may be software modules running in the processor 404, resident and/or stored in the computer-readable medium 406, one or more hardware modules coupled to the processor 404, or some combination thereof.

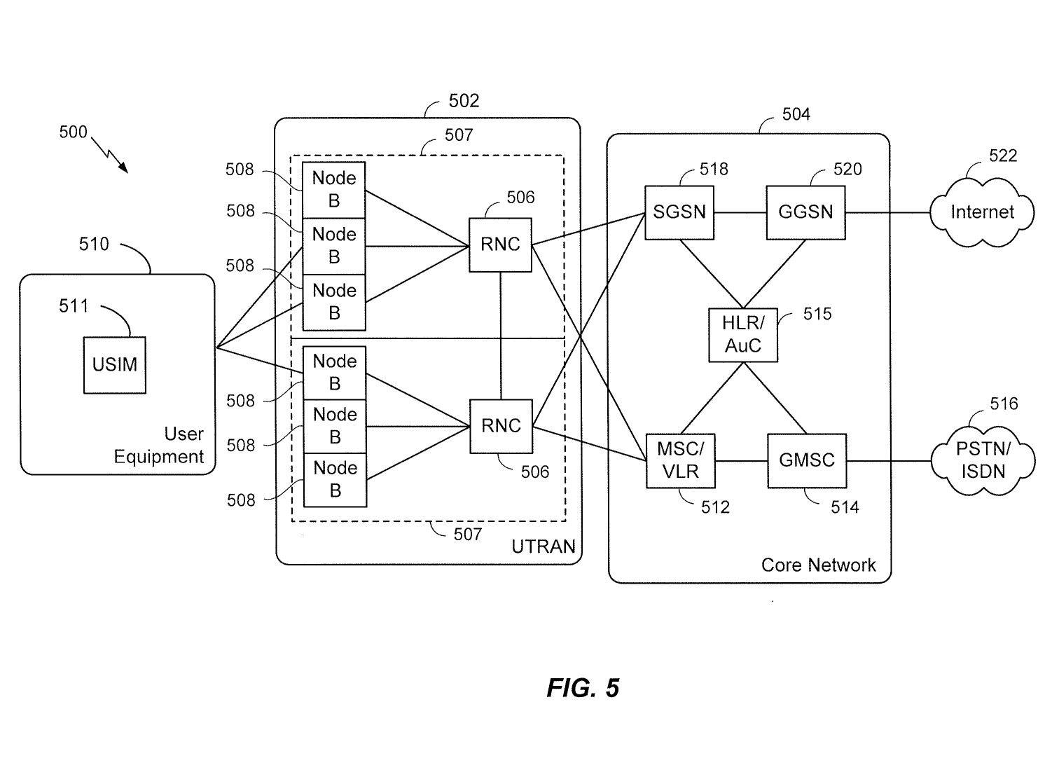

The various concepts presented throughout this disclosure may be implemented across a broad variety of telecommunication systems, network architectures, and communication standards. For example, because UE 110 may be a multimode and/or multiband device, it may be used across radio access technologies (RATs) and/or frequency bands. Referring to FIG. 5, a UE 510, which may be UE 110 of FIG. 1, and Node Bs 508, which may be base station 122 and/or base station 132 of FIG. 1, are in communication with one another.

By way of example and without limitation, the aspects of the present disclosure illustrated in FIG. 5 are presented with reference to a UMTS system 500 employing a W-CDMA air interface having aspects configured for efficient radio access technology frequency scanning based on false alarms. A UMTS network includes three interacting domains: a Core Network (CN) 504, a UMTS Terrestrial Radio Access Network (UTRAN) 502, and User Equipment (UE) 510. In this example, the UTRAN 502 provides various wireless services including telephony, video, data, messaging, broadcasts, and/or other services. The UTRAN 502 may include a plurality of Radio Network Subsystems (RNSs) such as an RNS 507, each controlled by a respective Radio Network Controller (RNC) such as an RNC 506. Here, the UTRAN 502 may include any number of RNCs 506 and RNSs 507 in addition to the RNCs 506 and RNSs 507 illustrated herein. The RNC 506 is an apparatus responsible for, among other things, assigning, reconfiguring and releasing radio resources within the RNS 507. The RNC 506 may be interconnected to other RNCs (not shown) in the UTRAN 502 through various types of interfaces such as a direct physical connection, a virtual network, or the like, using any suitable transport network.

Communication between a UE 510 and a Node B 508 may be considered as including a physical (PHY) layer and a medium access control (MAC) layer. Further, communication between a UE 510 and an RNC 506 by way of a respective Node B 508 may be considered as including a radio resource control (RRC) layer. In the instant specification, the PHY layer may be considered layer 1; the MAC layer may be considered layer 2; and the RRC layer may be considered layer 3. Information hereinbelow utilizes terminology introduced in the RRC Protocol Specification, 3GPP TS 25.331 v9.1.0, incorporated herein by reference.

The geographic region covered by the RNS 507 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 508 are shown in each RNS 507; however, the RNSs 507 may include any number of wireless Node Bs. The Node Bs 508 provide wireless access points to a CN 504 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 510 may further include a universal subscriber identity module (USIM) 511, which contains a user's subscription information to a network. For illustrative purposes, one UE 510 is shown in communication with a number of the Node Bs 508. The DL, also called the forward link, refers to the communication link from a Node B 508 to a UE 510, and the UL, also called the reverse link, refers to the communication link from a UE 510 to a Node B 508.

The CN 504 interfaces with one or more access networks, such as the UTRAN 502. As shown, the CN 504 is a GSM core network. However, as those skilled in the art will recognize, the various concepts presented throughout this disclosure may be implemented in a RAN, or other suitable access network, to provide UEs with access to types of CNs other than GSM networks.

The CN 504 includes a circuit-switched (CS) domain and a packet-switched (PS) domain. Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Some network elements, like EIR, HLR, VLR and AuC may be shared by both of the circuit-switched and packet-switched domains. In the illustrated example, the CN 504 supports circuit-switched services with a MSC 512 and a GMSC 514. In some applications, the GMSC 514 may be referred to as a media gateway (MGW). One or more RNCs, such as the RNC 506, may be connected to the MSC 512. The MSC 512 is an apparatus that controls call setup, call routing, and UE mobility functions. The MSC 512 also includes a VLR that contains subscriber-related information for the duration that a UE is in the coverage area of the MSC 512. The GMSC 514 provides a gateway through the MSC 512 for the UE to access a circuit-switched network 516. The GMSC 514 includes a home location register (HLR) 515 containing subscriber data, such as the data reflecting the details of the services to which a particular user has subscribed. The HLR is also associated with an authentication center (AuC) that contains subscriber-specific authentication data. When a call is received for a particular UE, the GMSC 514 queries the HLR 515 to determine the UE's location and forwards the call to the particular MSC serving that location.

The CN 504 also supports packet-data services with a serving GPRS support node (SGSN) 518 and a gateway GPRS support node (GGSN) 520. GPRS, which stands for General Packet Radio Service, is designed to provide packet-data services at speeds higher than those available with standard circuit-switched data services. The GGSN 520 provides a connection for the UTRAN 502 to a packet-based network 522. The packet-based network 522 may be the Internet, a private data network, or some other suitable packet-based network. The primary function of the GGSN 520 is to provide the UEs 510 with packet-based network connectivity. Data packets may be transferred between the GGSN 520 and the UEs 510 through the SGSN 518, which performs primarily the same functions in the packet-based domain as the MSC 512 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 508 and a UE 510. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 510 provides feedback to the Node B 508 over the HS-DPCCH to indicate whether it correctly decoded a packet on the downlink.

HS-DPCCH further includes feedback signaling from the UE 510 to assist the Node B 508 in taking the right decision in terms of modulation and coding scheme and precoding weight selection, this feedback signaling including the CQI and PCI.

“HSPA Evolved” or HSPA+ is an evolution of the HSPA standard that includes MIMO and 64-QAM, enabling increased throughput and higher performance. That is, in an aspect of the disclosure, the Node B 508 and/or the UE 510 may have multiple antennas supporting MIMO technology. The use of MIMO technology enables the Node B 508 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 510 to increase the data rate or to multiple UEs 510 to increase the overall system capacity. This is achieved by spatially precoding each data stream and then transmitting each spatially precoded stream through a different transmit antenna on the downlink. The spatially precoded data streams arrive at the UE(s) 510 with different spatial signatures, which enables each of the UE(s) 510 to recover the one or more the data streams destined for that UE 510. On the uplink, each UE 510 may transmit one or more spatially precoded data streams, which enables the Node B 508 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

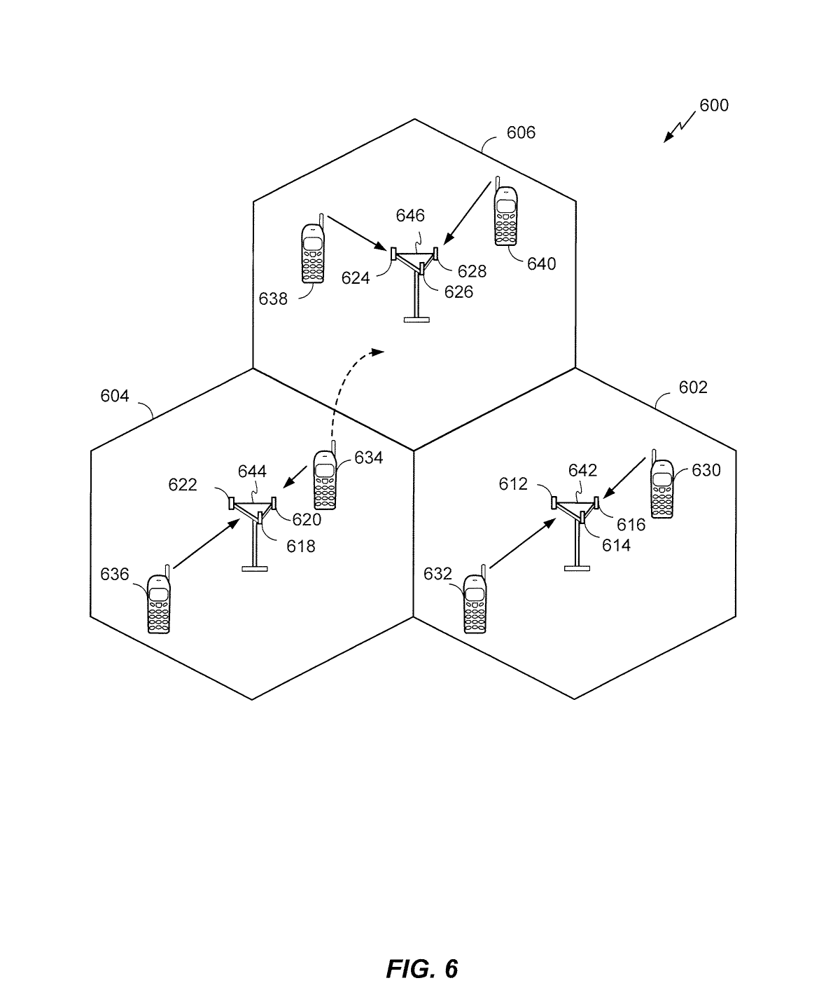

Referring to FIG. 6, an access network 600 in a UTRAN architecture having aspects configured for efficient radio access technology frequency scanning based on false alarms and in which UE 110 may operate, is illustrated. The multiple access wireless communication system includes multiple cellular regions (cells), including cells 602, 604, and 606, each of which may include one or more sectors. The multiple sectors can be formed by groups of antennas with each antenna responsible for communication with UEs in a portion of the cell. For example, in cell 602, antenna groups 612, 614, and 616 may each correspond to a different sector. In cell 604, antenna groups 618, 620, and 622 each correspond to a different sector. In cell 606, antenna groups 624, 626, and 628 each correspond to a different sector. The cells 602, 604 and 606 may include several wireless communication devices, e.g., User Equipment or UEs, which may be in communication with one or more sectors of each cell 602, 604 or 606. For example, UEs 630 and 632 may be in communication with Node B 642, UEs 634 and 636 may be in communication with Node B 644, and UEs 638 and 640 can be in communication with Node B 646. Here, each Node B 642, 644, 646 is configured to provide an access point to a CN 504 (see FIG. 5) for all the UEs 630, 632, 634, 636, 638, 640 in the respective cells 602, 604, and 606. In an aspect, UEs 630, 632, 634, 636, 638, and/or 640 may be UE 110 of FIG. 1, and Node B 642, 644, and/or 646 may be base station 122 and/or base station 132 of FIG. 1.

As the UE 634 moves from the illustrated location in cell 604 into cell 606, a serving cell change (SCC) or handover may occur in which communication with the UE 634 transitions from the cell 604, which may be referred to as the source cell, to cell 606, which may be referred to as the target cell. Management of the handover procedure may take place at the UE 634, at the Node Bs corresponding to the respective cells, at a radio network controller 506 (see FIG. 5), or at another suitable node in the wireless network. For example, during a call with the source cell 604, or at any other time, the UE 634 may monitor various parameters of the source cell 604 as well as various parameters of neighboring cells such as cells 606 and 602. Further, depending on the quality of these parameters, the UE 634 may maintain communication with one or more of the neighboring cells. During this time, the UE 634 may maintain an Active Set, that is, a list of cells that the UE 634 is simultaneously connected to (i.e., the UTRA cells that are currently assigning a downlink dedicated physical channel DPCH or fractional downlink dedicated physical channel F-DPCH to the UE 634 may constitute the Active Set).

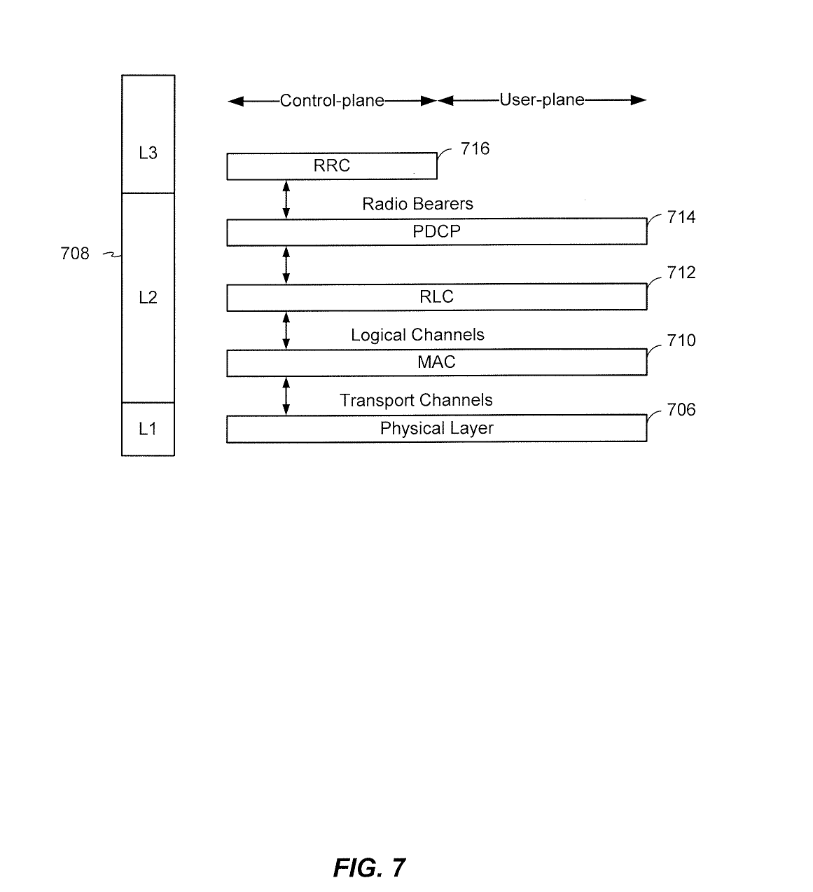

The modulation and multiple access scheme employed by the access network 600 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE, LTE Advanced, and GSM are described in documents from the 3GPP organization. CDMA2000 and UMB are described in documents from the 3GPP2 organization. The actual wireless communication standard and the multiple access technology employed will depend on the specific application and the overall design constraints imposed on the system. The radio protocol architecture may take on various forms depending on the particular application. An example for an HSPA system will now be presented with reference to FIG. 7.

Referring to FIG. 7, an example radio protocol architecture 700 relates to the user plane 702 and the control plane 704 of a user equipment (UE), such as, in an aspect, UE 110 of FIG. 1, having aspects configured for efficient radio access technology frequency scanning based on false alarms, or Node B/base station, such as, in an aspect, base station 122 and/or base station 132 of FIG. 1. The radio protocol architecture 700 for the UE and Node B is shown with three layers: Layer 1 706, Layer 2 708, and Layer 3 710. Layer 1 706 is the lowest lower and implements various physical layer signal processing functions. As such, Layer 1 706 includes the physical layer 707. Layer 2 (L2 layer) 708 is above the physical layer 707 and is responsible for the link between the UE and Node B over the physical layer 707. Layer 3 (L3 layer) 710 includes a radio resource control (RRC) sublayer 715. The RRC sublayer 715 handles the control plane signaling of Layer 3 between the UE and the UTRAN.

In the user plane, the L2 layer 708 includes a media access control (MAC) sublayer 709, a radio link control (RLC) sublayer 711, and a packet data convergence protocol (PDCP) 713 sublayer, which are terminated at the Node B on the network side. Although not shown, the UE may have several upper layers above the L2 layer 708 including a network layer (e.g., IP layer) that is terminated at a PDN gateway on the network side, and an application layer that is terminated at the other end of the connection (e.g., far end UE, server, etc.).

The PDCP sublayer 713 provides multiplexing between different radio bearers and logical channels. The PDCP sublayer 713 also provides header compression for upper layer data packets to reduce radio transmission overhead, security by ciphering the data packets, and handover support for UEs between Node Bs. The RLC sublayer 711 provides segmentation and reassembly of upper layer data packets, retransmission of lost data packets, and reordering of data packets to compensate for out-of-order reception due to hybrid automatic repeat request (HARQ). The MAC sublayer 709 provides multiplexing between logical and transport channels. The MAC sublayer 709 is also responsible for allocating the various radio resources (e.g., resource blocks) in one cell among the UEs. The MAC sublayer 709 is also responsible for HARQ operations.

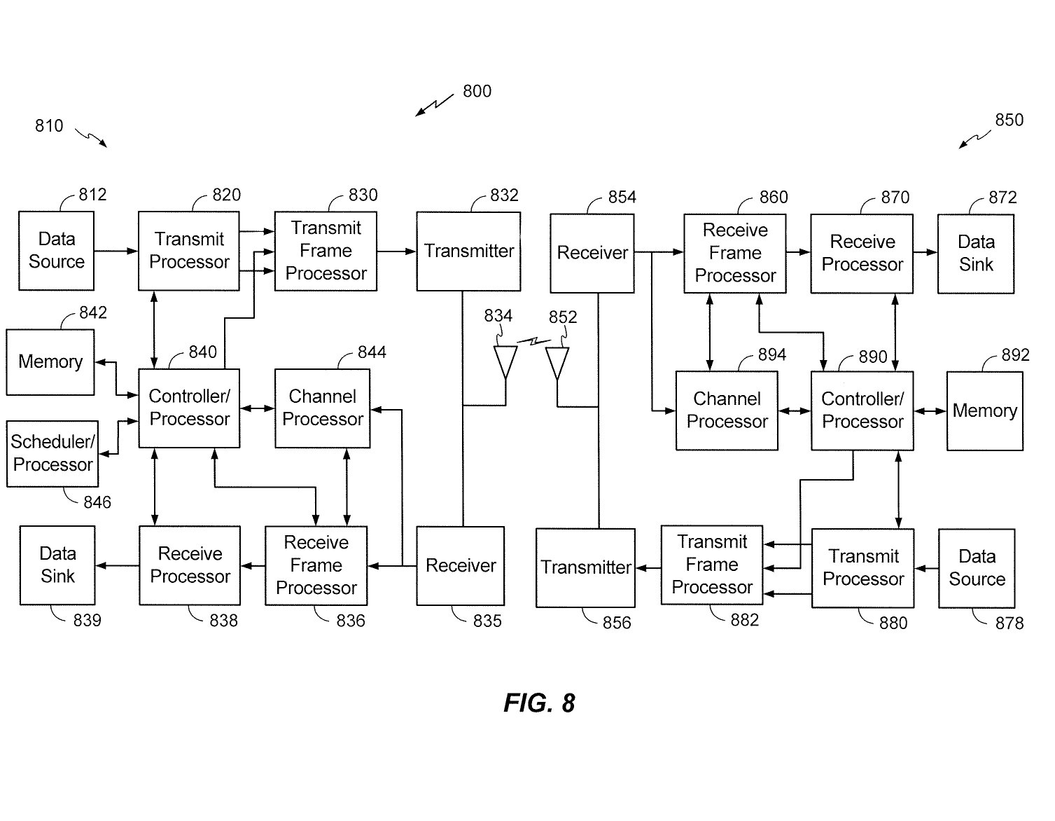

FIG. 8 is a block diagram of a Node B 810 in communication with a UE 850, where the Node B 810 may be the Node B 508 of FIG. 5, base station 122 and/or base station 132 of FIG. 1, and the UE 850, having aspects configured for efficient radio access technology frequency scanning based on false alarms, may be the UE 510 of FIG. 5 and/or UE 110 of FIG. 1.

In the downlink communication, a transmit processor 820 may receive data from a data source 812 and control signals from a controller/processor 840. The transmit processor 820 provides various signal processing functions for the data and control signals, as well as reference signals (e.g., pilot signals). For example, the transmit processor 820 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 844 may be used by a controller/processor 840 to determine the coding, modulation, spreading, and/or scrambling schemes for the transmit processor 820. These channel estimates may be derived from a reference signal transmitted by the UE 850 or from feedback from the UE 850. The symbols generated by the transmit processor 820 are provided to a transmit frame processor 830 to create a frame structure. The transmit frame processor 830 creates this frame structure by multiplexing the symbols with information from the controller/processor 840, resulting in a series of frames. The frames are then provided to a transmitter 832, which provides various signal conditioning functions including amplifying, filtering, and modulating the frames onto a carrier for downlink transmission over the wireless medium through antenna 834. The antenna 834 may include one or more antennas, for example, including beam steering bidirectional adaptive antenna arrays or other similar beam technologies.

At the UE 850, a receiver 854 receives the downlink transmission through an antenna 852 and processes the transmission to recover the information modulated onto the carrier. The information recovered by the receiver 854 is provided to a receive frame processor 860, which parses each frame, and provides information from the frames to a channel processor 894 and the data, control, and reference signals to a receive processor 870. The receive processor 870 then performs the inverse of the processing performed by the transmit processor 820 in the Node B 810. More specifically, the receive processor 870 descrambles and despreads the symbols, and then determines the most likely signal constellation points transmitted by the Node B 810 based on the modulation scheme. These soft decisions may be based on channel estimates computed by the channel processor 894. The soft decisions are then decoded and deinterleaved to recover the data, control, and reference signals. The CRC codes are then checked to determine whether the frames were successfully decoded. The data carried by the successfully decoded frames will then be provided to a data sink 872, which represents applications running in the UE 850 and/or various user interfaces (e.g., display). Control signals carried by successfully decoded frames will be provided to a controller/processor 890. When frames are unsuccessfully decoded by the receiver processor 870, the controller/processor 890 may also use an acknowledgement (ACK) and/or negative acknowledgement (NACK) protocol to support retransmission requests for those frames.

In the uplink, data from a data source 878 and control signals from the controller/processor 890 are provided to a transmit processor 880. The data source 878 may represent applications running in the UE 850 and various user interfaces (e.g., keyboard). Similar to the functionality described in connection with the downlink transmission by the Node B 810, the transmit processor 880 provides various signal processing functions including CRC codes, coding and interleaving to facilitate FEC, mapping to signal constellations, spreading with OVSFs, and scrambling to produce a series of symbols. Channel estimates, derived by the channel processor 894 from a reference signal transmitted by the Node B 810 or from feedback contained in the midamble transmitted by the Node B 810, may be used to select the appropriate coding, modulation, spreading, and/or scrambling schemes. The symbols produced by the transmit processor 880 will be provided to a transmit frame processor 882 to create a frame structure. The transmit frame processor 882 creates this frame structure by multiplexing the symbols with information from the controller/processor 890, resulting in a series of frames. The frames are then provided to a transmitter 856, which provides various signal conditioning functions including amplification, filtering, and modulating the frames onto a carrier for uplink transmission over the wireless medium through the antenna 852.

The uplink transmission is processed at the Node B 810 in a manner similar to that described in connection with the receiver function at the UE 850. A receiver 835 receives the uplink transmission through the antenna 834 and processes the transmission to recover the information modulated onto the carrier. The information recovered by the receiver 835 is provided to a receive frame processor 836, which parses each frame, and provides information from the frames to the channel processor 844 and the data, control, and reference signals to a receive processor 838. The receive processor 838 performs the inverse of the processing performed by the transmit processor 880 in the UE 850. The data and control signals carried by the successfully decoded frames may then be provided to a data sink 839 and the controller/processor, respectively. If some of the frames were unsuccessfully decoded by the receive processor, the controller/processor 840 may also use an acknowledgement (ACK) and/or negative acknowledgement (NACK) protocol to support retransmission requests for those frames.

The controller/processors 840 and 890 may be used to direct the operation at the Node B 810 and the UE 850, respectively. For example, the controller/processors 840 and 890 may provide various functions including timing, peripheral interfaces, voltage regulation, power management, and other control functions. The computer readable media of memories 842 and 892 may store data and software for the Node B 810 and the UE 850, respectively. A scheduler/processor 846 at the Node B 810 may be used to allocate resources to the UEs and schedule downlink and/or uplink transmissions for the UEs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM□, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of frequency scanning for wireless communication, comprising:
selecting a first radio access technology associated with multiple frequency bands;
selecting a first frequency band from among the multiple frequency bands;
performing a first signal scan associated with the first radio access technology in the first frequency band;
identifying at least one candidate signal in the first frequency band;
signaling a false alarm by determining that the at least one candidate signal is not associated with the first radio access technology;
storing candidate signal information as false alarm information related to the at least one candidate signal;
selecting a second radio access technology associated with at least one of the multiple frequency bands;
selecting a second frequency band from among the at least one of the multiple frequency bands based on the stored false alarm information; and
performing a second signal scan associated with the second radio access technology in the second frequency band.

2. The method of claim 1, wherein storing the candidate signal information as false alarm information comprises:
determining that the at least one candidate signal has a power level above a threshold power value; and
wherein the storing of the candidate signal information is based on the power level being above the threshold power value.

3. The method of claim 1, wherein storing the candidate signal information as false alarm information comprises storing at least one of a frequency, a band type, and a power level for each false alarm, wherein the band type is one of a narrow band or a wide band.

4. The method of claim 3, further comprising sorting the false alarm information based on at least one of the frequency, the band type and the power level.

5. The method of claim 3, further comprising sorting the false alarm information in decreasing order of power level associated with each of the false alarms.

6. The method of claim 1, wherein selecting the second frequency band comprises:
selecting a prioritization scheme based on the second radio access technology;
prioritizing individual false alarms, each of which is associated with a candidate signal, within the stored false alarm information based on the selected prioritization scheme; and
retrieving the prioritized false alarm information,
wherein the selecting of the second frequency band comprises selecting a frequency band associated with the at least one candidate signal having a highest priority based on the prioritizing.

7. The method of claim 1,
wherein the first radio access technology is associated with a first band type, and
wherein signaling a false alarm by determining that the at least one candidate signal is not associated with the first radio access technology comprises signaling a false alarm by determining that the at least one candidate signal is associated with a second band type that is different from the first band type.

8. The method of claim 7, wherein the first band type and second band type are each one of a narrow band or a wide band.

9. The method of claim 1, further comprising:
identifying a target signal in the second frequency band during the second signal scan;
determining that the target signal is associated with the second radio access technology;
determining that the target signal is suitable for camping; and
camping on the target signal.

10. The method of claim 9, wherein determining that the target signal is associated with the second radio access technology comprises determining that the target signal is associated with a band type that is the same as a band type associated with the second radio access technology.

11. The method of claim 10, wherein the band type comprises one of a narrow band or a wide band.

12. The method of claim 1, wherein the selecting of the first radio access technology associated with multiple frequency bands comprises selecting the first radio access technology based on at least one of a default setting, a user input, a determination of a current geographic location, and a wireless service provider input.

13. A non-transitory computer-readable medium for frequency scanning for wireless communication, comprising code that, when executed by a processor or processing system included within a user equipment, causes the user equipment to:
select a first radio access technology associated with multiple frequency bands;
select a first frequency band from among the multiple frequency bands;
perform a first signal scan associated with the first radio access technology in the first frequency band;
identify at least one candidate signal in the first frequency band;
signal a false alarm by determining that the at least one candidate signal is not associated with the first radio access technology;
store candidate signal information as false alarm information;
select a second radio access technology associated with at least one of the multiple frequency bands;
select a second frequency band from among the at least one of the multiple frequency bands based on the stored false alarm information; and
perform a second signal scan associated with the second radio access technology in the second frequency band.

14. An apparatus for frequency scanning for wireless communication, comprising:
means for selecting a first radio access technology associated with multiple frequency bands;
means for selecting a first frequency band from among the multiple frequency bands;
means for performing a first signal scan associated with the first radio access technology in the first frequency band;
means for identifying at least one candidate signal in the first frequency band;
means for signaling a false alarm by determining that the at least one candidate signal is not associated with the first radio access technology;
means for storing information related to the at least one candidate signal;
means for selecting a second radio access technology associated with at least one of the multiple frequency bands;
means for selecting a second frequency band from among the at least one of the multiple frequency bands based on the stored false alarm information; and
means for performing a second signal scan associated with the second radio access technology in the second frequency band.

15. An apparatus for frequency scanning for wireless communication, comprising:
a mode module configured to select a first radio access technology associated with multiple frequency bands;
a band module configured to select a first frequency band from among the multiple frequency bands;
a scanner module configured to perform a first signal scan associated with the first radio access technology in the first frequency band; and
a false alarm detector module configured to:
identify at least one candidate signal in the first frequency band,
signal a false alarm by determining that the at least one candidate signal is not associated with the first radio access technology, and
store candidate signal information as false alarm information,
wherein the mode module is further configured to select a second radio access technology associated with at least one of the multiple frequency bands,
wherein the band module is further configured to select a second frequency band from among the at least one of the multiple frequency bands based on the stored false alarm information, and
wherein the scanner module is further configured to perform a second signal scan associated with the second radio access technology in the second frequency band.

16. The apparatus of claim 15, wherein the false alarm detector module being configured to store the candidate signal information as false alarm information comprises the false alarm detector module configured to:
determine that the at least one candidate signal has a power level above a threshold power value,
wherein the false alarm detector module is configured to store the candidate signal information based on the power level being above the threshold power value.

17. The apparatus of claim 15, wherein the false alarm detector module being configured to store the candidate signal information as false alarm information comprises the false alarm detector module configured to store at least one of a frequency, a band type, and a power level for each false alarm, wherein the band type is one of a narrow band or a wide band.

18. The apparatus of claim 17, further comprising a false alarm sorter module configured to sort the false alarm information based on at least one of the frequency, the band type and the power level.

19. The apparatus of claim 17, further comprising a false alarm sorter module configured to sort the false alarm information in decreasing order of power level associated with each of the false alarms.

20. The apparatus of claim 15, wherein the mode module being configured to select the second frequency band comprises the mode module configured to:
select a prioritization scheme based on the second radio access technology;
prioritize individual false alarms, each of which is associated with a candidate signal, within the stored false alarm information based on the selected prioritization scheme; and
retrieve the prioritized false alarm information,
wherein the mode module being configured to select the second frequency band comprises the mode module configured to select a frequency band associated with the at least one candidate signal having a highest priority based on the prioritizing.

21. The apparatus of claim 15,
wherein the first radio access technology is associated with a first band type, and
wherein the false alarm detector module being configured to signal a false alarm by determining that the at least one candidate signal is not associated with the first radio access technology comprises the false alarm detector module configured to signal a false alarm by determining that the at least one candidate signal is associated with a second band type that is different from the first band type.

22. The apparatus of claim 21, wherein the first band type and second band type are each one of a narrow band or a wide band.

23. The apparatus of claim 15,
wherein the scanner module is further configured to:
identify a target signal in the second frequency band during the second signal scan, and
determine that the target signal is associated with the second radio access technology, and
further comprising a camping module configured to:
determine that the target signal is suitable for camping; and
camp on the target signal.

24. The apparatus of claim 23, wherein the scanner module being configured to determine that the target signal is associated with the second radio access technology comprises the scanner module configured to determine that the target signal is associated with a band type that is the same as a band type associated with the second radio access technology.

25. The apparatus of claim 24, wherein the band type comprises one of a narrow band or a wide band.

26. The apparatus of claim 15, wherein the mode module being configured to select of the first radio access technology associated with multiple frequency bands comprises the mode module configured to select the first radio access technology based on at least one of a default setting, a user input, a determination of a current geographic location, and a wireless service provider input.
